(19) United States
(12) Patent Application Publication
(10) Pub. No.: US 2025/0245932 A1
(43) Pub. Date: Jul. 31, 2025

(54) TILE PROCESSING AND TRANSFORMATION FOR VIDEO SEE-THROUGH (VST) EXTENDED REALITY (XR)

(71) Applicant: Samsung Electronics Co., Ltd., Suwon-si (KR)

(72) Inventors: Yingen Xiong, Mountain View, CA (US); Christopher A. Peri, Mountain View, CA (US)

(21) Appl. No.: 18/670,525

(22) Filed: May 21, 2024

Related U.S. Application Data
(60) Provisional application No. 63/625,889, filed on Jan. 26, 2024.

(51) Int. Cl. G06T 19/00; G06F 3/01; G06T 5/80

(52) U.S. Cl. CPC G06T 19/006; G06F 3/012; G06F 3/013; G06T 5/80

(57) ABSTRACT

A method includes obtaining a first tile corresponding to a first portion of an image frame and a second tile corresponding to a second portion of the image frame after the first tile. The method also includes mapping the first and second tiles onto first and second distortion tile meshes, respectively. The method further includes predicting a head pose of a user when the image frame will be displayed. The method also includes transforming the first and second distortion tile meshes based on the predicted head pose. The second distortion tile mesh is transformed after the first distortion tile mesh. The method further includes rendering the first and second tiles based on the first and second transformed distortion tile meshes, respectively. The second tile is rendered after the first tile. In addition, the method includes initiating display of the first and second rendered tiles on at least one display panel.

### CROSS-REFERENCE TO RELATED APPLICATIONS AND PRIORITY CLAIM

This application claims priority under 35 U.S.C. § 119 (e) to U.S. Provisional Patent Application No. 63/625,889 filed on Jan. 26, 2024. This provisional patent application is hereby incorporated by reference in its entirety.

### TECHNICAL FIELD

This disclosure relates generally to extended reality (XR) systems and processes. More specifically, this disclosure relates to tile processing and transformation for video see-through (VST) XR.

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

### SUMMARY

This disclosure relates to tile processing and transformation for video see-through (VST) extended reality (XR).

In a first embodiment, a method includes obtaining, using at least one imaging sensor of a VST XR device, (i) a first tile corresponding to a first portion of an image frame and (ii) a second tile corresponding to a second portion of the image frame after the first tile is obtained. The method also includes mapping, using at least one processing device of the VST XR device, the first tile onto a first distortion tile mesh, where the first distortion tile mesh is based on one or more characteristics of the first tile. The method further includes mapping, using the at least one processing device, the second tile onto a second distortion tile mesh, where the second distortion tile mesh is based on one or more characteristics of the second tile. The method also includes predicting, using the at least one processing device, a head pose of a user when the image frame will be displayed. The method further includes transforming, using the at least one processing device, the first and second distortion tile meshes based on the predicted head pose, where the second distortion tile mesh is transformed after the first distortion tile mesh. The method also includes rendering, using the at least one processing device, the first and second tiles for display based on the first and second transformed distortion tile meshes, respectively, where the second tile is rendered after the first tile. In addition, the method includes initiating, using the at least one processing device, display of the first and second rendered tiles on at least one display panel of the VST XR device.

In a second embodiment, a VST XR device includes at least one imaging sensor configured to (i) capture a first tile corresponding to a first portion of an image frame and (ii) capture a second tile corresponding to a second portion of the image frame after the first tile is captured. The VST XR device also includes at least one processing device configured to map the first tile onto a first distortion tile mesh, where the first distortion tile mesh is based on one or more characteristics of the first tile. The at least one processing device is also configured to map the second tile onto a second distortion tile mesh, where the second distortion tile mesh is based on one or more characteristics of the second tile. The at least one processing device is further configured to predict a head pose of a user when the image frame will be displayed. The at least one processing device is also configured to transform the first and second distortion tile meshes based on the predicted head pose, where the at least one processing device is configured to transform the second distortion tile mesh after the first distortion tile mesh. The at least one processing device is further configured to render the first and second tiles for display based on the first and second transformed distortion tile meshes, respectively, where the at least one processing device is configured to render the second tile after the first tile. In addition, the at least one processing device is configured to initiate display of the first and second rendered tiles on at least one display panel of the VST XR device.

In a third embodiment, a non-transitory machine readable medium contains instructions that when executed cause at least one processor of a VST XR device to obtain, using at least one imaging sensor of the VST XR device, (i) a first tile corresponding to a first portion of an image frame and (ii) a second tile corresponding to a second portion of the image frame after the first tile is obtained. The non-transitory machine readable medium also contains instructions that when executed cause the at least one processor to map the first tile onto a first distortion tile mesh, where the first distortion tile mesh is based on one or more characteristics of the first tile. The non-transitory machine readable medium further contains instructions that when executed cause the at least one processor to map the second tile onto a second distortion tile mesh, where the second distortion tile mesh is based on one or more characteristics of the second tile. The non-transitory machine readable medium also contains instructions that when executed cause the at least one processor to predict a head pose of a user when the image frame will be displayed. The non-transitory machine readable medium further contains instructions that when executed cause the at least one processor to transform (i) the first distortion tile mesh based on the predicted head pose and (ii) the second distortion tile mesh based on the predicted head pose after the first distortion tile mesh is transformed. The non-transitory machine readable medium also contains instructions that when executed cause the at least one processor to render (i) the first tile for display based on the first transformed distortion tile mesh and (ii) the second tile for display based on the second transformed distortion tile mesh after the first tile is rendered. In addition, the non-transitory machine readable medium contains instructions that when executed cause the at least one processor to initiate display of the first and second rendered tiles on at least one display panel of the VST XR device.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIGS. 2A through 2D illustrate example processes for generating image frames for presentation in video see-through (VST) extended reality (XR) in accordance with this disclosure;

FIGS. 3A and 3B illustrate an example architecture supporting tile processing and transformation for VST XR in accordance with this disclosure;

FIGS. 4A and 4B illustrate an example process for capturing tiles in an alternating manner in accordance with this disclosure;

FIGS. 5 and 6 illustrate an example process for capturing, processing, and rendering tiles of an image frame in accordance with this disclosure;

FIGS. 7A through 7D illustrate example configurations of tiles of an image frame in accordance with this disclosure;

FIG. 8 illustrates an example process for projecting tiles onto a virtual image plane in accordance with this disclosure;

FIG. 9 illustrates an example method for supporting tile processing and transformation for VST XR in accordance with this disclosure;

FIG. 10 illustrates an example method for dynamically controlling numbers and resolutions of tiles in accordance with this disclosure; and

FIG. 11 illustrates an example method for identifying a tile distortion mesh for use in transforming a tile in accordance with this disclosure.

### DETAILED DESCRIPTION

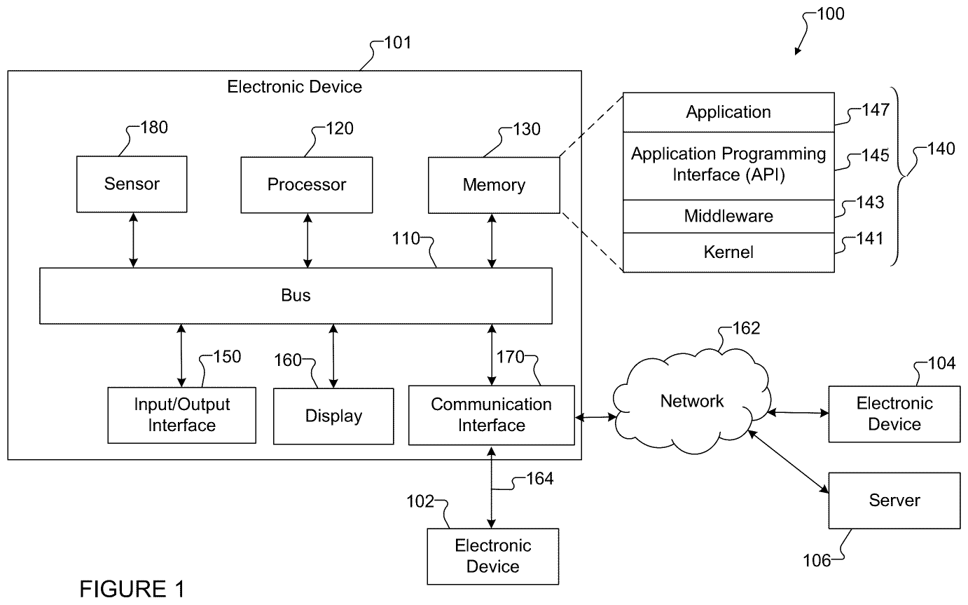

FIGS. 1 through 11, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

Optical see-through (OST) XR systems refer to XR systems in which users directly view real-world scenes through head-mounted devices (HMDs). Unfortunately, OST XR systems face many challenges that can limit their adoption. Some of these challenges include limited fields of view, limited usage spaces (such as indoor-only usage), failure to display fully-opaque black objects, and usage of complicated optical pipelines that may require projectors, waveguides, and other optical elements. In contrast to OST XR systems, video see-through (VST) XR systems (also called “passthrough” XR systems) present users with generated video sequences of real-world scenes. VST XR systems can be built using virtual reality (VR) technologies and can have various advantages over OST XR systems. For example, VST XR systems can provide wider fields of view and can provide improved contextual augmented reality.

Many VST XR devices use high-resolution cameras, such as 3K or 4K images, along with high-resolution frame transformation and frame rendering, to generate images for display to users. However, the capture, processing, and rendering of high-resolution images can be computationally expensive, which can slow down generation and presentation of the images to the users. This latency can negatively affect a user's experience with a VST XR device, since latency in generating and presenting images to the user can be immediately noticed by the user. In some cases, larger latencies may cause the user to feel uncomfortable or even suffer from motion sickness or other effects.

This disclosure provides various techniques supporting tile processing and transformation for VST XR. As described in more detail below, multiple tiles (such as first and second tiles) corresponding to different portions of an image frame can be obtained. The multiple tiles can be obtained sequentially such that the second tile is obtained after the first tile is obtained. Each tile can be mapped onto an associated distortion tile mesh, and the distortion tile mesh can be based on one or more characteristics of the corresponding tile. A head pose of a user when the image frame will be displayed can be predicted, and each distortion tile mesh can be transformed based on the predicted head pose. The distortion tile meshes can be transformed sequentially such that the second distortion tile mesh is transformed after the first distortion tile mesh. The tiles are rendered for display based on the corresponding distortion tile meshes. The tiles can be rendered sequentially such that the second tile is rendered after the first tile. Display of the rendered tiles on at least one display panel of the VST XR device can be initiated, such as after the first and second rendered tiles are combined. In some embodiments, a multi-threaded approach can be used, where different threads executed by one or more processing devices can be used to obtain and process different tiles of the image frame. Moreover, in some embodiments, the number of tiles used and the resolutions of those tiles can vary dynamically, such as when a higher-resolution tile is used in an area of a scene where the user provides his or her focus. In some cases, more than two tiles can be captured, processed, and rendered for the image frame. Also, depending on the implantation, the two or more tiles may or may not overlap with one another. In addition, this can be repeated for any number of image frames.

In this way, these techniques allow for different operations to occur for different tiles at the same time, such as when a first tile is being rendered while a second tile is being processed and a third tile is being captured. Moreover, different processing threads may be used here, such as when different threads are used to capture, process, and render each tile of an image frame. Thus, for instance, one thread may be used to capture, process, and render the first tile of each of a sequence of image frames, another thread may be used to capture, process, and render the second tile of each of a sequence of image frames, etc. Among other things, the described techniques can significantly reduce the latency of a VST XR pipeline, which may increase the speed at which image frames are presented to a user of the VST XR device. Depending on the implementation, the described techniques may cut the overall time for presenting each image frame by up to half or even more. This can also reduce the processing load on the VST XR device and/or allow for an increased frame rate. Overall, the described techniques can help to provide improved user experiences with VST XR devices.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to tile processing and transformation for VST XR.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform tile processing and transformation for VST XR. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include cameras or other imaging sensors, which may be used to capture images of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to tile processing and transformation for VST XR.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

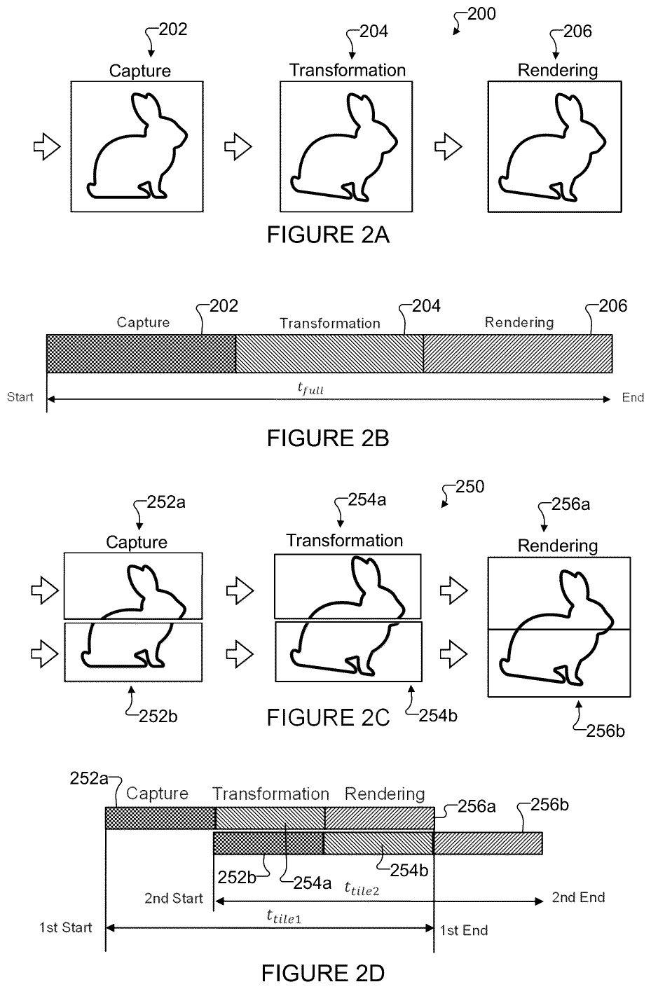

FIGS. 2A through 2D illustrate example processes for generating image frames for presentation in VST XR in accordance with this disclosure. As shown in FIGS. 2A and 2B, a standard process 200 for generating an image frame for presentation is shown. As can be seen in FIG. 2A, the entire image frame is obtained during a capture operation 202, processed during a transformation operation 204, and rendered during a rendering operation 206. As can be seen in FIG. 2B, these operations 202-206 occur sequentially, meaning the transformation operation 204 is performed after the capture operation 202 is completed and the rendering operation 206 is performed after the transformation operation 204 is completed. Because of this, it can take a relatively long period of time tfull to capture, process, and render a full-resolution image frame, and the time typically becomes greater as the resolution of the image frame increases. Moreover, the capture operation 202 for the next image frame does not begin until the rendering operation 206 of the current image frame is completed.

As shown in FIGS. 2C and 2D, a tile-based process 250 for generating an image frame for presentation is shown. As can be seen in FIG. 2C, rather than obtaining an entire image frame, the image frame is divided into tiles. Each tile represents a portion of an image frame. In this example, the image frame is formed using two tiles (one upper and one lower), although the number and arrangement of tiles can vary. Also, while the two tiles here do not overlap, there may be some overlap between the tiles as discussed below.

As can be seen in FIGS. 2C and 2D, one tile is captured during a capture operation 252a, and another tile is captured during a capture operation 252b (which occurs after the capture operation 252a). One tile is processed during a transformation operation 254a, and another tile is processed during a transformation operation 254b (which occurs after the transformation operation 254a). One tile is rendered for display during a rendering operation 256a, and another tile is rendered for display during a rendering operation 256b (which occurs after the rendering operation 256a). The period of time tₜᵢₗₑ₁ for generating a first rendered tile and the period of time tₜᵢₗₑ₂ for generating a second rendered tile are each individually smaller than the time t_{full} since less image data is being processed for each tile. In some cases, each of the capture operations 252a-252b may take about half the time as the capture operation 202, each of the transformation operations 254a-254b may take about half the time as the transformation operation 204, and each of the rendering operations 256a-256b may take about half the time as the rendering operation 206. Moreover, the operations 254a and 252b can overlap with one another, and the operations 256a and 254b can overlap with one another. As a result, the entire period of time needed to process all image data for the full image frame is less than the time t_{full} (possibly about half of the time t_{full}).

While not shown here, another capture operation 252a for the next image frame can overlap with the last rendering operation 256b for the current image frame. Thus, the capture operation 252a for the first tile of the first image frame may occur by itself since there is no parallel processing to be performed, but after that there might be no gaps in the two parallel processing paths. In this way, the capturing, processing, and rendering of multiple image tiles can overlap. All of these features can lead to reduced latency and therefore allow image frames to be presented more rapidly to a user. As described below, in some embodiments, different computing threads may be used to capture, process, and render different tiles in order to support this parallel tile processing.

Although FIGS. 2A through 2D illustrate examples of processes 200, 250 for generating image frames for presentation in VST XR, various changes may be made to FIGS. 2A through 2D. For example, while the tile-based process 250 is shown here as involving two tiles per image frame, more than two tiles may be captured, processed, and rendered for each image frame in the tile-based process 250. Also, additional operations may be included in the tile-based process 250 as needed or desired.

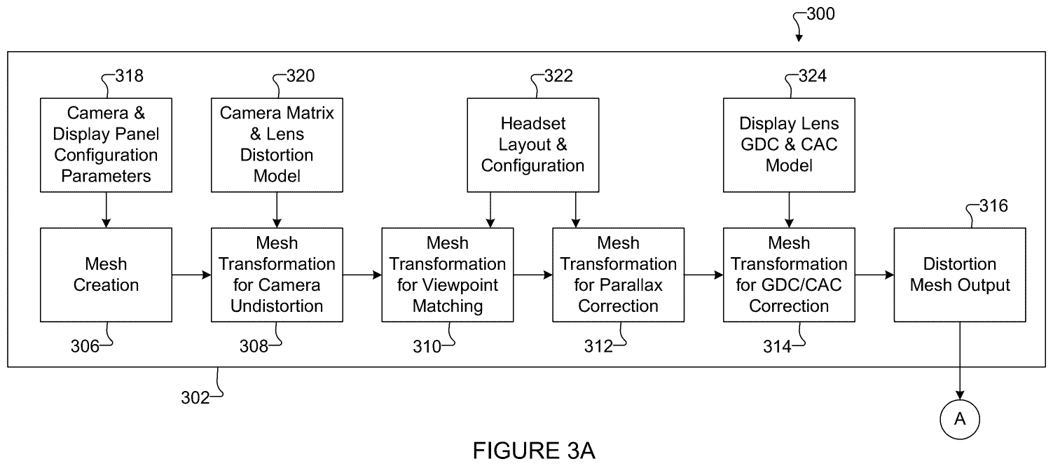

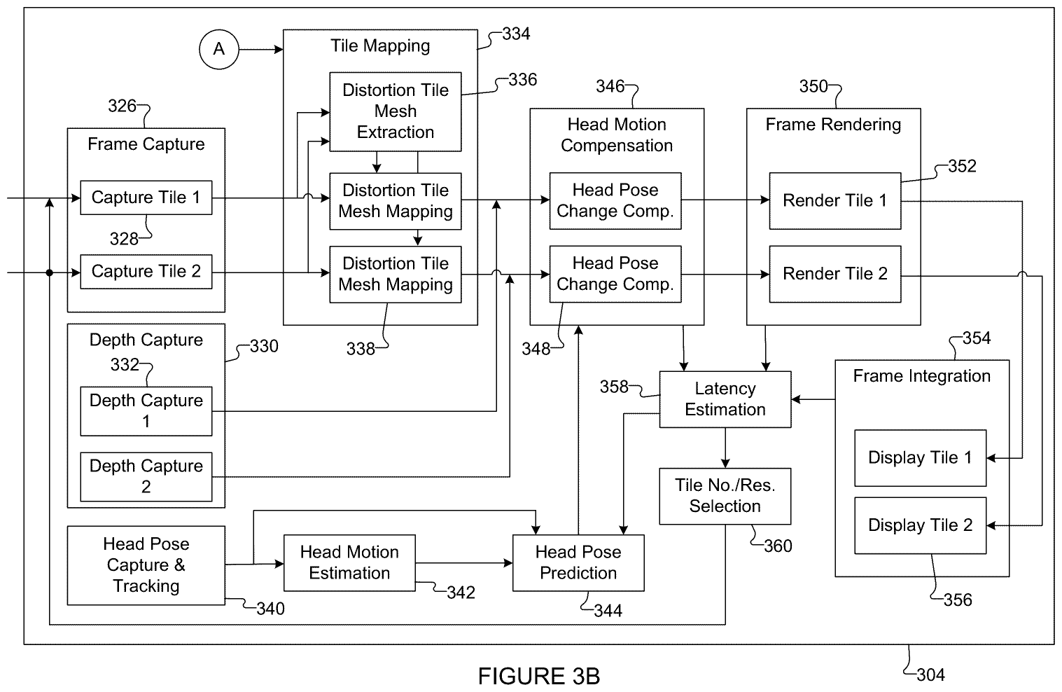

FIGS. 3A and 3B illustrate an example architecture 300 supporting tile processing and transformation for VST XR in accordance with this disclosure. For ease of explanation, the architecture 300 of FIGS. 3A and 3B is described as being implemented using the electronic device 101 in the network configuration 100 of FIG. 1, where the architecture 300 may perform the tile-based process 250 of FIGS. 2C and 2D. However, the architecture 300 may be implemented using any other suitable device(s) and in any other suitable system(s), and the architecture 300 may be used with any other suitable tile-based processes.

As shown in FIGS. 3A and 3B, the architecture 300 is generally divided into two primary operations, namely a static processing operation 302 that involves determining static distortion meshes to be applied to image frames and a dynamic processing operation 304 that involves applying the static distortion meshes to actual image frames. In some embodiments, the static processing operation 302 may be performed once when a VST XR device is being used, such as during an initialization of the VST XR device that is performed each time the VST XR device is powered on.

As shown in FIG. 3A, the static processing operation 302 generally involves a sequence of functions 306-316 that are performed to generate distortion meshes. A distortion mesh represents a mesh of points that defines how image frames can be transformed or distorted to correct for various issues. In this example, a mesh creation function 306 is used to create an initial base distortion mesh. In some cases, the initial base distortion mesh may be based on one or more characteristics of the at least one imaging sensor 180 that is used to capture image frames to be processed. For example, the mesh creation function 306 may include or have access to camera and display panel configuration parameters 318, which can define parameters of one or more imaging sensors 180 (such as one or more see-through cameras) used to capture image frames and one or more displays 160 (such as one or more display panels) used to present rendered images. The configuration parameters 318 may identify any suitable characteristics of the imaging sensor(s) 180 and display(s) 160, such as sizes/resolutions and locations of the imaging sensor(s) 180 and display(s) 160. The initial base distortion mesh here can identify how an image frame captured using each imaging sensor 180 might need to be distorted for proper presentation on the associated display 160. The mesh creation function 306 may use any suitable technique to identify the initial base distortion mesh.

The subsequent functions 308-314 transform the initial base distortion mesh to correct for various issues within a VST XR device. For example, a mesh transformation function 308 may modify the initial base distortion mesh to provide camera undistortion. An imaging sensor 180 used in or with a VST XR device typically includes at least one lens, and the at least one lens can create radial, tangential, or other type(s) of distortion(s) in captured image frames. The mesh transformation function 308 can make adjustments to the initial base distortion mesh so that the resulting distortion mesh substantially corrects for the radial, tangential, or other type(s) of distortion(s). In some cases, the mesh transformation function 308 may include or have access to a camera matrix and lens distortion model 320, which can be used to identify how the input distortion mesh should be adjusted so that the resulting distortion mesh substantially corrects for the camera lens distortion(s). A camera matrix is often defined as a three-by-three matrix that includes two focal lengths in the x and y directions and the principal point of the camera defined using x and y coordinates. A lens distortion model is often defined as a mathematical model that indicates how images can be undistorted, which can be derived based on the specific lens or other optical component(s) being used.

A mesh transformation function 310 may modify its input distortion mesh in order to provide viewpoint matching, and a mesh transformation function 312 may modify its input distortion mesh in order to provide parallax correction. With respect to viewpoint matching, a VST XR device often includes one or more see-through cameras or other imaging sensors 180, and the VST XR device operates to present images to a user's eyes. The imaging sensors 180 are located in positions other than the positions of the user's eyes, which leads to different viewpoints of a scene between the imaging sensors 180 and the user's eyes. The mesh transformation function 310 generally operates to make adjustments to its input distortion mesh so that the resulting distortion mesh compensates for these different viewpoints. Thus, for instance, the mesh transformation function 310 may determine translations and rotations needed to convert the viewpoints of the imaging sensors 180 to the viewpoints of the user's eyes, and the mesh transformation function 310 can adjust its input distortion mesh to implement these translations and rotations. These adjustments can be derived, for instance, based on known geometries of the VST XR device.

With respect to parallax correction, parallax refers to the difference in apparent positions of common points when viewed along different lines of sight. In a VST XR device, because the imaging sensors 180 are located at different positions than the user's eyes, the parallax at left and right imaging sensors 180 may be different than the parallax at left and right eyes of the user. The mesh transformation function 312 generally operates to make adjustments to its input distortion mesh so that the resulting distortion mesh compensates for this difference in parallax. Thus, for instance, the mesh transformation function 312 may determine how object points or other points within a captured scene would differ between image planes associated with the imaging sensors 180 and image planes associated with the user's eyes, and the mesh transformation function 312 can adjust its input distortion mesh to implement these adjustments. Again, these adjustments can be derived, for instance, based on the known geometries of the VST XR device.

In some cases, the mesh transformation functions 310 and 312 may operate based on a headset layout and configuration 322, which can identify various characteristics of the VST XR device. For example, the headset layout and configuration 322 may identify where the see-through cameras or other imaging sensors 180 are located on the VST XR device and where the user's eyes are expected to be positioned when the VST XR device is in use. The headset layout and configuration 322 can also identify whether the imaging sensors 180 are pointing straight ahead or have some other orientations. Using this type of information, the mesh transformation function 310 can determine the different viewpoints of the imaging sensors 180 and the user's eyes and how the compensate for these different viewpoints. Similarly, using this type of information, the mesh transformation function 312 can determine different parallax of the imaging sensors 180 and the user's eyes and how the compensate for the different parallax.

A mesh transformation function 314 may modify its input distortion mesh in order to provide geometric distortion correction (GDC) and chromatic aberration correction (CAC). In many VST XR devices, rendered image frames are presented on one or more displays 160, such as left and right display panels or left and right portions of a common display panel. Also, rendered image frames are often viewed by the user through left and right display lenses positioned between the user's eyes and the display panel(s). However, the display lenses may create geometric distortions when displayed images are viewed, and the display lenses may create chromatic aberrations when light passes through the display lenses. The mesh transformation function 314 generally operates to make adjustments to its input distortion mesh so that the resulting distortion mesh compensates for the geometric distortions and the chromatic aberrations. Thus, for instance, the mesh transformation function 314 may determine how image frames should be pre-distorted to compensate for the subsequent geometric distortions and chromatic aberrations created when the image frames are displayed and viewed through the display lenses. In some cases, the mesh transformation function 314 may operate based on a display lens GDC and CAC model 324, which can mathematically represent the geometric distortions and chromatic aberrations created by the display lenses.

The resulting distortion mesh generated using the functions 306-314 can be provided to a distortion mesh output function 316, which may store the distortion mesh and provide the distortion mesh to the dynamic processing operation 304 when needed. In some embodiments, the static processing operation 302 may be performed multiple times to generate different distortion meshes, such as distortion meshes having different resolutions. As a particular example, the static processing operation 302 may be used to generate a lower-resolution distortion mesh having a standard resolution and a higher-resolution distortion mesh having a higher resolution than the standard resolution. As described below, in some cases, the higher-resolution distortion mesh may be applied to tiles representing a portion of a scene on which the user's eyes are focused (which may be referred to as foveation rendering), while the lower-resolution distortion mesh may be applied to tiles representing portions of the scene on which the user's eyes are not focused.

As shown in FIG. 3B, the dynamic processing operation 304 involves a number of functions that capture, process, and render tiles of image frames for presentation to the user of the VST XR device. A frame capture function 326 is used to capture tiles of image frames for processing. In this example, there are two capture sub-functions 328, which can be used to capture two tiles of each image frame. As noted above, however, more than two tiles may be captured for each image frame. In the following discussion, it is assumed that two tiles are captured for each image frame, but various functions in the dynamic processing operation 304 can be easily expanded to handle more than two tiles per image frame. The capture sub-functions 328 can generally operate to capture tiles of an image frame sequentially at different times, such as when the “tile 2” capture sub-function 328 captures its tile after the “tile 1” capture sub-function 328 captures its tile. This can occur in an alternating manner in which the sub-functions 328 are repeatedly switched back and forth to capture tiles for different image frames.

A depth capture function 330 can be used to generate depth maps or otherwise identify depths within a scene being captured within the tiles of the image frames. In this example, there are two depth capture sub-functions 332, which can be used to capture depths within two tiles of each image frame (although the number of sub-functions 332 can be expanded). In some cases, each depth map may include values that identify relative or absolute depths of corresponding pixels within one or more of the captured tiles. Each depth map may be obtained in any suitable manner, such as by using a depth sensor or other sensor(s) 180 of the electronic device 101 or by performing depth reconstruction in which depth values in a scene are derived based on stereo image frames or tiles of the scene (where disparities in locations of common points in the stereo images or tiles are used to estimate depths). As a particular example, each depth map may be generated by obtaining an initial depth map and increasing the resolution of the initial depth map (often referred to as “densification”) using depth super-resolution and depth verification operations. The capture sub-functions 332 can generally operate to capture depths sequentially at different times, such as when the “tile 2” capture sub-function 332 captures its depths after the “tile 1” capture sub-function 332 captures its depths. This can occur in an alternating manner in which the sub-functions 332 are repeatedly switched back and forth to capture tiles for different image frames.

A tile mapping function 334 generally operates to map each of the captured tiles onto a respective distortion tile mesh. In this example, a distortion tile mesh extraction sub-function 336 is used to extract (from one or more of the distortion meshes generated by the static processing operation 302) distortion tile meshes that correspond to the captured tiles, where each distortion tile mesh is based on one or more characteristics of its corresponding tile. For example, for each tile, the distortion tile mesh extraction sub-function 336 may identify the position, size, and resolution for that tile and extract a portion of a distortion mesh generated by the static processing operation 302 having the same position, size, and resolution. Each extracted portion of a distortion mesh is referred to as a distortion tile mesh. In some embodiments, for instance, if the captured tiles for each image frame have the same resolution, the distortion tile mesh extraction sub-function 336 may extract multiple portions of the lower-resolution distortion mesh and use those extracted portions as the distortion tile meshes. If the captured tiles for each image frame have different resolutions, the distortion tile mesh extraction sub-function 336 may extract different portions of the lower-resolution and higher-resolution distortion meshes and use those extracted portions as the distortion tile meshes.

Multiple distortion tile mesh mapping sub-functions 338 map the captured tiles to the distortion tile meshes provided by the distortion tile mesh extraction sub-function 336. For example, the distortion tile mesh mapping sub-functions 338 may identify points within the captured tiles and corresponding points (which may be in different positions) within the distortion tile meshes provided by the distortion tile mesh extraction sub-function 336. In this example, there are two distortion tile mesh mapping sub-functions 338 since there are two tiles being processed for each image frame (although the number of sub-functions 338 can be expanded). The mapping sub-functions 338 can generally operate to perform mappings sequentially at different times, such as when the “tile 2” mapping sub-function 338 maps its tile after the “tile 1” mapping sub-function 338 maps its tile. This can occur in an alternating manner in which the mapping sub-functions 338 are repeatedly switched back and forth to map tiles for different image frames.

A head pose capture and tracking function 340 can be used to obtain information related to the head pose of the user using the VST XR device and how the user's head pose changes over time. For example, the head pose capture and tracking function 340 may obtain inputs from an IMU, a head pose tracking camera, or other sensor(s) 180 of the electronic device 101 when the tiles of the image frames are being captured. The head pose capture and tracking function 340 can also track how these inputs are changing. This information can be provided to a head pose estimation function 342, which can use this information to estimate the current head pose of the user. For instance, various information from the head pose capture and tracking function 340 may be used to build a model of the user's head poses, and the head pose estimation function 342 can apply this model to information from the head pose capture and tracking function 340 to estimate the current head pose of the user.

Information from the head pose capture and tracking function 340 and the user's current estimated head pose from the head pose estimation function 342 can be provided to a head pose prediction function 344. The head pose prediction function 344 can be used to estimate what the user's head pose will likely be when captured tiles are actually displayed as an image frame to the user. In many cases, for instance, a tile of an image frame will be captured at one time and subsequently displayed some amount of time later to the user, and it is possible for the user to move his or her head during this intervening time period. The head pose prediction function 344 can therefore be used to estimate, for each tile or image frame, what the user's head pose will likely be when a rendered version of that tile or image frame will be displayed to the user.

A head motion compensation function 346 generally operates to adjust the distortion tile meshes provided by the tile mapping function 334 based on the predicted head pose of the user provided by the head pose prediction function 344. The head motion compensation function 346 here uses the prediction of what the head pose of the user will be when the tile or image frame will be displayed, and the head motion compensation function 346 can adjust the distortion tile meshes so that the rendered tiles or image frame appears to have been captured at the user's new head pose. The head motion compensation function 346 here can compensate for the user's head movement, which in some embodiments can be based on the depth data from the depth capture function 330. In some cases, multiple head pose change compensation sub-functions 348 can adjust the distortion tile meshes based on the predicted head pose and generate multiple transformed distortion tile meshes. In this example, there are two head pose change compensation sub-functions 348 since there are two tiles being processed (although the number of sub-functions 348 can be expanded). The compensation sub-functions 348 can generally operate to perform compensations sequentially at different times, such as when the “tile 2” compensation sub-function 348 operates after the “tile 1” compensation sub-function 348 operates. This can occur in an alternating manner in which the compensation sub-functions 348 are repeatedly switched back and forth to apply head pose compensation for different image frames.

While this example shows the use of depth-based reprojection as part of the head motion compensation function 346, this is not necessarily required. For example, constant-depth or planar reprojection may be performed as part of the head motion compensation function 346, where the compensation sub-functions 348 do not require depths within the scene to perform the head motion compensation. As particular examples, if the user focuses his or her attention on reading a computer screen or a mobile device screen, a defaulted constant depth (which could be based on the device type) may be used. Also, in some cases, a head pose change may only involve a rotational change and not a translation change. In those cases, a time warp operation may be used to determine the head motion compensation without needing to use depths within the scene.

A rendering function 350 processes the captured tiles using the transformed distortion tile meshes in order to generate final rendered tiles. The final rendered tiles represent the final version of an image frame that appears as if it was captured from the perspective of the user's eyes at the predicted head pose of the user. In some cases, multiple tile rendering sub-functions 352 can apply the transformed distortion tile meshes to the captured tiles in order to transform the captured tiles to the desired viewpoint. In this example, there are two tile rendering sub-functions 352 since there are two tiles being processed (although the number of sub-functions 352 can be expanded). The tile rendering sub-functions 352 can generally operate to perform rendering sequentially at different times, such as when the “tile 2” tile rendering sub-function 352 renders its tile after the “tile 1” tile rendering sub-function 352 renders its tile. This can occur in an alternating manner in which the tile rendering sub-functions 352 are repeatedly switched back and forth to render tiles for different image frames.

A frame integration function 354 processes the rendered tiles in order to display an integrated image frame to the user. In some cases, multiple tile display sub-functions 356 can initiate display of their respective rendered tiles. For example, in some cases, the tile display sub-functions 356 may initiate display of their respective rendered tiles at substantially the same time, thereby combining the rendered tiles into a single displayed image frame. In other cases, the tile display sub-functions 356 may alternate display of the rendered tiles such that the rendered tiles are displayed at different times (even for the same image frame).

Note that the above process can be repeated any number of times to capture, process, and render tiles for any number of image frames being presented to the user. Moreover, the above process can be repeated for image frames captured using multiple see-through cameras or other imaging sensors 180, such as when the above process is performed for image frames captured using a left imaging sensor 180 for presentation to the user's left eye and for image frames captured using a right imaging sensor 180 for presentation to the user's right eye. In addition, as shown in FIG. 2D, the processing of multiple consecutive image frames can overlap, where different functions in the dynamic processing operation 304 are used to process tiles for different image frames. In some embodiments, tiles are obtained, processed, and rendered using different computing threads executed by one or more processors 120 of the VST XR device. For example, different threads may include different sub-functions 328, different sub-functions 332, different sub-functions 338, different sub-functions 348, different sub-functions 352, and different sub-functions 356. When there are two tiles per image frame, there may be two computing threads. More generally, when there are n tiles per image frame, there may be n computing threads (where n≥2).

In this example, a latency estimation function 358 is used to identify the estimated latency between capture of tiles and display of rendered versions of those tiles. For example, the latency estimation function 358 may estimate the amount of time needed for various operations in the architecture 300 to be performed for various tiles, such as by identifying times between when tiles are captured and times when one or more other functions (such as tile mapping, head motion compensation, rendering, and/or integration) are completed. The latency estimation function 358 can provide an estimated latency to the head pose prediction function 344. The head pose prediction function 344 can use the estimated latency to predict what the user's head poses will be in the future after a time period that represents the estimated latency has elapsed. This allows the head pose prediction function 344 to predict, for each tile or image frame, the user's head pose based on the expected latency of the tile processing pipeline. Note that the latency can change over time, and the latency estimation function 358 is able to identify current latency of the tile processing pipeline so that the head pose prediction function 344 can dynamically consider the changing latencies when predicting the user's head pose over time.

The latency estimation function 358 can also provide the estimated latency to a tile number and resolution selection function 360, which generally operates to select the number of tiles captured for each image frame and to select the resolution used with each tile. In some cases, these selections can be based on the current performance of the tile processing pipeline. For example, the selection function 360 may choose to capture, process, and render a larger number of tiles per image frame using a larger number of computing threads when the tile processing pipeline is not at or near a processing limit, or the selection function 360 may choose to capture, process, and render a smaller number of tiles per image frame using a smaller number of computing threads when the tile processing pipeline is at or above the processing limit. The selection function 360 could also or alternatively use higher-resolution tiles when the tile processing pipeline is not at or near the processing limit and lower-resolution tiles when the tile processing pipeline is at or above the processing limit. In some cases, based on the selected number of tiles, the selection function 360 can also determine a size of each tile, such as by identifying tiles of relatively equal sizes. As a particular example, to support foveation rendering, the selection function 360 may identify the area of a scene where the user is focusing his or her attention (such as based on one or more eye tracking sensors or other sensors 180 of the electronic device 101) and define one higher-resolution tile for that area, and the selection function 360 may identify one or more lower-resolution tiles for other (non-focus) areas in the scene. The selected number of tiles and resolution(s) can be fed back and used to adjust the tiles being captured of future image frames.

Although FIGS. 3A and 3B illustrate one example of an architecture 300 supporting tile processing and transformation for VST XR, various changes may be made to FIG. 3. For example, various components or functions in FIG. 3 may be combined, further subdivided, replicated, omitted, or rearranged and additional components or functions may be added according to particular needs. As a particular example, the specific order of the functions 308-314 in FIG. 3A could vary. Also, as noted above, more than two tiles may be captured, processed, and rendered for each image frame, and various functions of the architecture 300 can be easily expanded (such as by using additional computing threads) to accommodate more than two tiles per image frame.

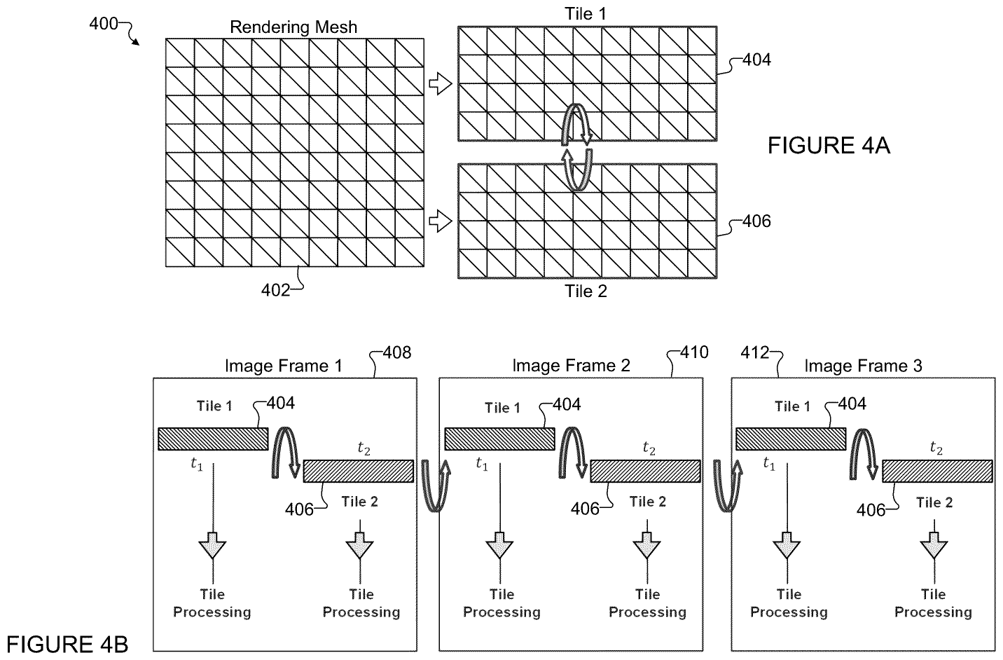

FIGS. 4A and 4B illustrate an example process 400 for capturing tiles in an alternating manner in accordance with this disclosure. For ease of explanation, the process 400 of FIGS. 4A and 4B is described as being performed using the electronic device 101 in the network configuration 100 of FIG. 1, where the electronic device 101 may perform the tile-based process 250 of FIGS. 2C and 2D and support the architecture 300 of FIGS. 3A and 3B. However, the process 400 may be performed using any other suitable device(s) and in any other suitable system(s), and the process 400 may be used with any other suitable tile-based processes and architectures.

As shown in FIG. 4A, a rendering mesh 402 is defined and is associated with each full or complete image frame to be captured, processed, and rendered. Based on a selected number of tiles (two in this case), the rendering mesh 402 is split into two tile sub-meshes defining a first tile 404 and a second tile 406. In this example, the sub-meshes are defined such that the tiles 404 and 406 are generally equal in size and do not overlap. However, one or both of these conditions may not be needed, such as when the sub-meshes define tiles 404 and 406 having different sizes and/or define overlapping tiles 404 and 406.

As shown in FIG. 4B, the capturing of the tiles 404 and 406 occurs in an alternating and synchronized manner. That is, the first tile 404 of a first image frame 408 can be captured. While the first tile 404 of the first image frame 408 is being processed, the second tile 406 of the first image frame 408 can be captured. While the second tile 406 of the first image frame 408 is being processed, the first tile 404 of a second image frame 410 can be captured. While the first tile 404 of the second image frame 410 is being processed, the second tile 406 of the second image frame 410 can be captured. While the second tile 406 of the second image frame 410 is being processed, the first tile 404 of a third image frame 412 can be captured. While the first tile 404 of the third image frame 412 is being processed, the second tile 406 of the third image frame 412 can be captured.

This allows each tile 404-406 of each image frame 408-412 to be captured, processed, and rendered in order to display rendered image frames to a user. Moreover, this allows operations involving the tiles 404-406 of the image frames 408-412 to be staggered so that the capture of each tile (other than the first tile 404 of the first image frame 408) overlaps with the processing of at least one other tile. In some cases, multi-threaded processing can be used to support the capture, transformation, and rendering processes, one thread per tile, and the tiles can be captured in an alternating manner where one tile capture completes and another tile capture starts.

Since there are two tiles 404-406 here and each tile is about one half the size of the original rendering mesh 402, the capture of each tile 404-406 may need only about half the time needed to capture an entire image frame. Thus, the next tile capture can start immediately after the current tile capture completes. As a result, this can save about half of the time needed for a full-frame capture in multi-threaded environment. Processing and transformation of the two tiles can be performed simultaneously with multiple threads, which can reduce latency and improve the performance of the VST XR pipeline.

Although FIGS. 4A and 4B illustrate one example of a process 400 for capturing tiles in an alternating manner, various changes may be made to FIGS. 4A and 4B. For example, while two tiles are shown here, the process 400 may include any suitable number of tiles.

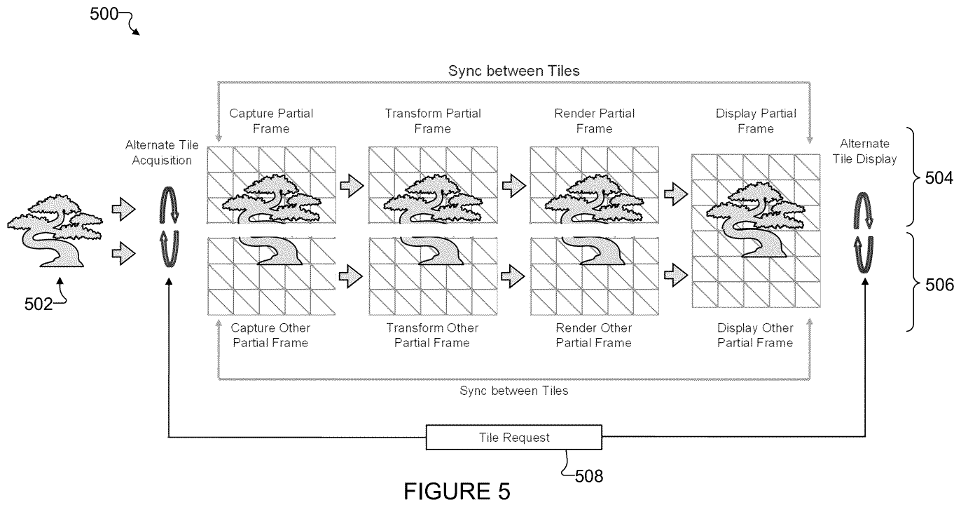

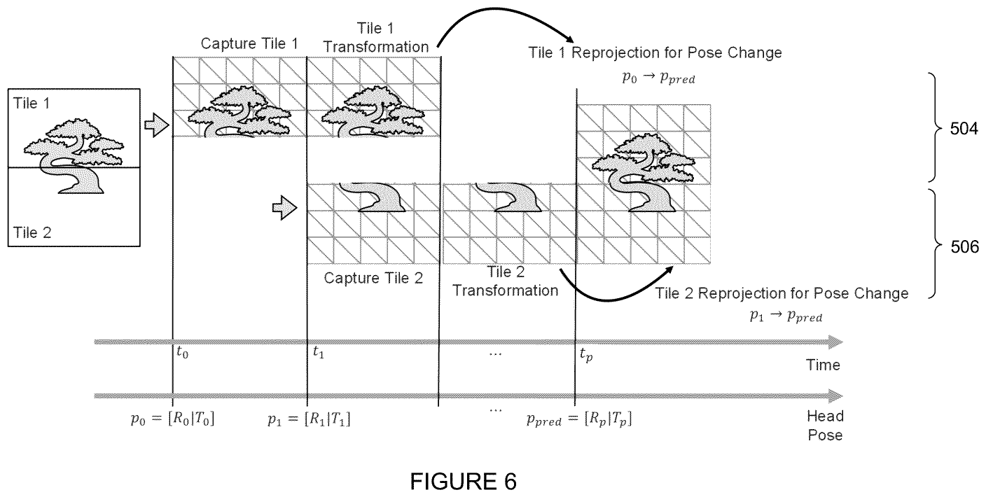

FIGS. 5 and 6 illustrate an example process 500 for capturing, processing, and rendering tiles of an image frame in accordance with this disclosure. For ease of explanation, the process 500 of FIGS. 5 and 6 is described as being performed using the electronic device 101 in the network configuration 100 of FIG. 1, where the electronic device 101 may perform the tile-based process 250 of FIGS. 2C and 2D and support the architecture 300 of FIGS. 3A and 3B. However, the process 500 may be performed using any other suitable device(s) and in any other suitable system(s), and the process 500 may be used with any other suitable tile-based processes and architectures.

As shown in FIG. 5, a scene 502 is being imaged and includes at least one object (a tree in this example). A determination is made by the tile number and resolution selection function 360 that two tiles should be captured for each image frame. An equal number of threads 504-506 (two in this example) can be created and executed. Each thread 504-506 can perform operations to capture, transform, render, and display one tile for each image frame. The threads 504-506 can be synchronized so that corresponding operations in the threads 504-506 are performed one right after the other. For instance, the capture of “tile 1” for an image frame may be completed, and the capture of “tile 2” for the same image frame may immediately start. Each thread 504-506 can include operations that support tile transformation, such as camera undistortion, viewpoint matching, parallax correction, GDC/CAC correction, and head pose change compensation. With these transformations, a final view of each captured tile can be generated, rendered, and displayed. Note that since the tiles are captured in an alternating manner, there is a time gap between tile captures, and there is a corresponding time gap between rendering. As long as the time gap is small enough, the user should not be able to perceive it.

In this example, tile requests 508 can be issued by the VST XR pipeline to control when tiles are captured and displayed. For example, the tile requests 508 can be staggered so that the different threads 504-506 can captured in an alternating manner. This can help to provide synchronization between the threads 504-506 and can enable the tiles to be captured and processed in parallel.

FIG. 6 provides an example of how the operations in the threads 504-506 can be staggered in order to allow parallel capturing, processing, and rendering of multiple tiles per image frame. As shown in FIG. 6, the first tile is captured and undergoes a transformation to account for a head pose change in the thread 504, and the second tile is captured and undergoes a transformation to account for the head pose change in the thread 506. These operations are staggered so that the first tile is processed while the second tile is being captured. The transformation of the first tile here modifies the first tile based on the predicted head pose of the user, and the transformation of the second tile here modifies the second tile based on the predicted head pose of the user.

Suppose that the first tile is captured at time to and with a camera pose p₀. The camera pose p₀ could be defined as follows.

p₀=[R₀|T₀]
Here, R₀ is a rotation matrix at time t₀, and T₀ is a translation vector at time t₀. Also suppose that the second tile is captured at time t₁ (which occurs immediately after capture of the first tile is completed) and with a camera pose p₁. The camera pose p₁ could be defined as follows.

p₁=[R₁|T₁]

Here, R₁ is a rotation matrix at time t₁, and T₁ is a translation vector at time t₁. Each tile undergoes at least one transformation, and latency of the VST XR pipeline can be estimated in order to predict head motion by a user during the time that the at least one transformation is being performed. For example, based the estimated latency and a head motion model, a predicted head pose p_{pred} may be determined as follows.

p_{pred}=[Rₚ|Tₚ]
Here, Rₚ is a rotation matrix at time tₚ, and Tₚ is a translation vector at time tₚ.

Based on this, the first tile can be transformed and then reprojected from the head pose p₀ to the head pose p_{pred} to generate a final view for that tile. In some cases, this can be expressed as follows.

fₜ₁(x,y)= [symbol] (f₀(x,y),p₀,p_{pred})

Here, fₜ₁(x, y) is the reprojected first tile, and f₀(x, y) is the transformed first tile. Similarly, the second tile can be transformed and then reprojected from the head pose p₁ to the head pose p_{pred} to generate a final view for that tile. In some cases, this can be expressed as follows.

fₜ₂(x,y)=R [symbol] (f₁(x,y),p₁,p_{pred})
Here, fₜ₂(x, y) is the reprojected second tile, and f₁(x, y) is the transformed second tile. The first and second reprojected tiles may be integrated to create a final frame fₜ(x, y), which may be expressed as follows.

$${f}_{t} ( x , y ) = \{ \begin{matrix}{f}_{t 1} ( x , y ) \\ {f}_{t 2} ( x , y )\end{matrix}$$

Although FIGS. 5 and 6 illustrate one example of a process 500 for capturing, processing, and rendering tiles of an image frame, various changes may be made to FIGS. 5 and 6. For example, while two tiles are shown here, the process 500 may include any suitable number of tiles and associated computing threads.

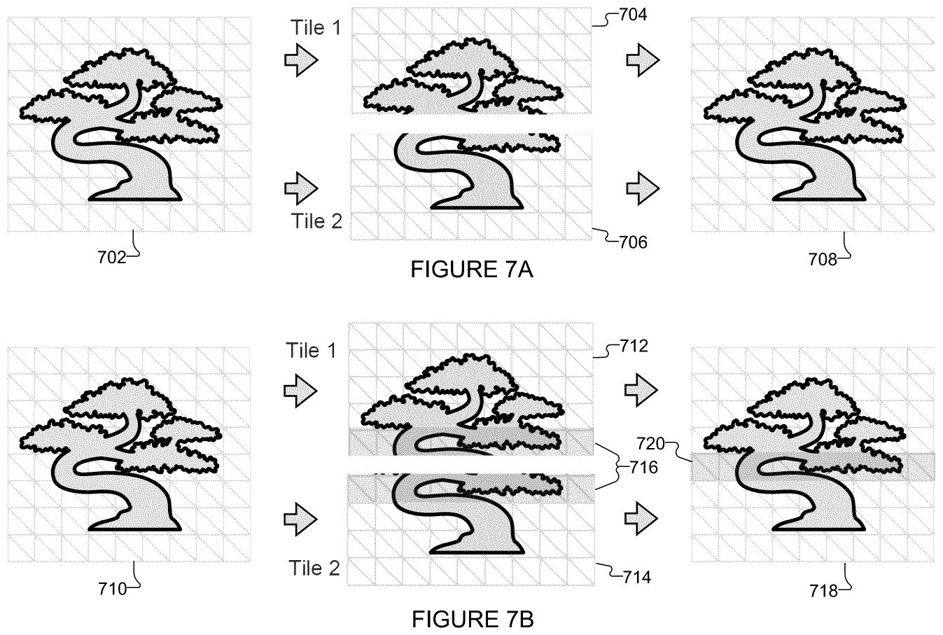

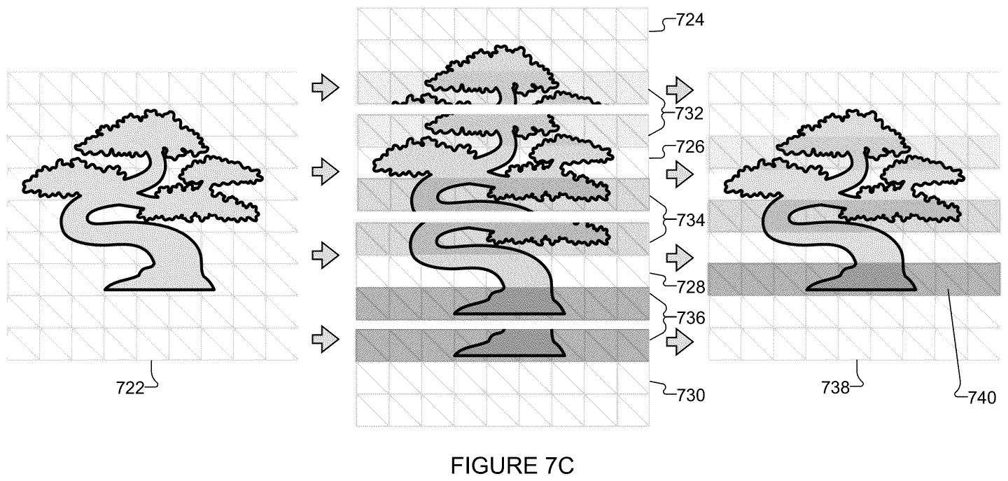

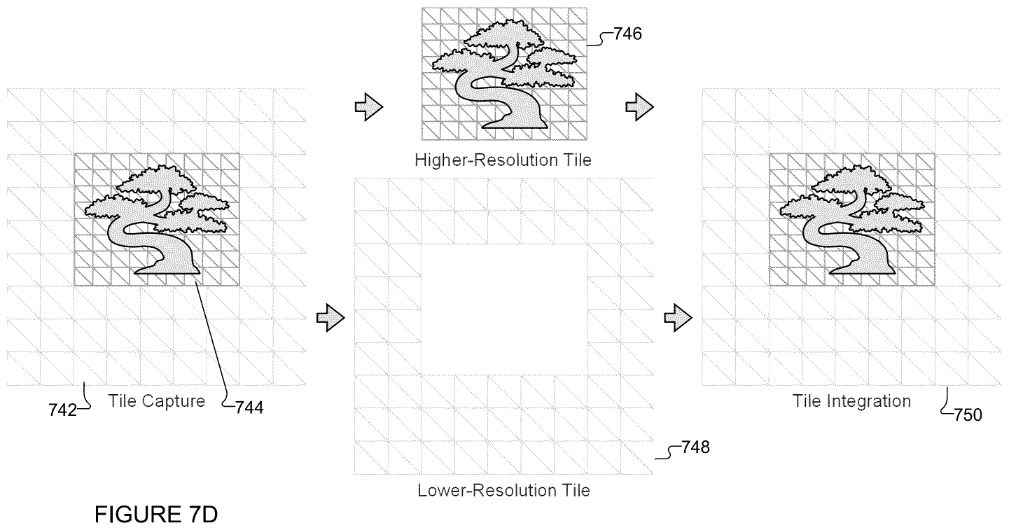

FIGS. 7A through 7D illustrate example configurations of tiles of an image frame in accordance with this disclosure. More specifically, FIGS. 7A through 7D illustrate examples of how two or more tiles may be defined to capture an image frame. Any of these configurations or other suitable configurations of tiles may be used in the architecture 300 and various processes described above. As shown in FIG. 7A, an image frame 702 can be divided into two non-overlapping tiles 704 and 706. The tiles 704 and 706 can be processed and used to generate a rendered image frame 708 associated with the image frame 702.

As shown in FIG. 7B, an image frame 710 can be divided into two overlapping tiles 712 and 714. The tiles 712 and 714 here include overlap regions 716 in which the tiles 712 and 714 capture a common portion of the image frame 710. The tiles 712 and 714 can be processed and used to generate a rendered image frame 718 associated with the image frame 710. A portion 720 of the rendered image frame 718 is associated with the overlap regions 716 and can be generated in any suitable manner, such as by using the contents of one of the overlap regions 716, blending the contents of the overlap regions 716, or using each of the tiles 712 and 714 to generate different pixels in the portion 720 of the rendered image frame 718. The use of overlapping tiles may be useful or provide certain benefits, such as reducing filling errors or other errors by capturing and processing more image data to generate the portion 720 of the rendered image frame 718.

In FIGS. 7A and 7B, there are two tiles per image frame. However, any suitable number of overlapping or non-overlapping tiles may be generated per image frame, such as three or more tiles. As an example, as shown in FIG. 7C, an image frame 722 can be divided into four overlapping tiles 724-730. The tiles 724-726 here include overlap regions 732 in which the tiles 724-726 capture a common portion of the image frame 722, the tiles 726-728 here include overlap regions 734 in which the tiles 726-728 capture a common portion of the image frame 722, and the tiles 728-730 here include overlap regions 736 in which the tiles 728-730 capture a common portion of the image frame 722. The tiles 724-730 can be processed and used to generate a rendered image frame 738 associated with the image frame 722. Different portions 740 of the rendered image frame 738 are associated with different groups of overlap regions 732-736. Each portion 740 of the rendered image frame 738 can be generated in any suitable manner, including those mentioned above.

As shown in FIG. 7D, an image frame 742 is associated with an area 744 in which the user is directing his or her focus. The image frame 742 can be divided into two tiles 746 and 748. The tile 746 includes the area 744 in which the user is directing his or her focus, and the tile 748 includes other portions of the image frame 742. The tile 746 can have a higher resolution than the tile 748 since the user will likely be focusing on that tile 746. The tiles 746 and 748 can be processed and used to generate a rendered image frame 750 associated with the image frame 742. The portion of the image frame 750 corresponding to the tile 746 has the higher resolution, while the portions of the image frame 750 corresponding to the tile 748 have the lower resolution. This approach supports the use of foveation rendering, where the user's region of interest is identified (such as based on eye tracking or other suitable technique) and used to define the tile 746 as being the area of the user's interest. This area can be rendered at higher resolution and with more detail, while other areas can be rendered at lower resolution and with less detail. This can help to improve performance of the VST XR pipeline and reduce latency.

Although FIGS. 7A through 7D illustrate examples of configurations of tiles of an image frame, various changes may be made to FIGS. 7A through 7D. For example, any suitable number of tiles may be used to capture an image frame, and each tile can have any suitable size, shape, and dimensions. Also, the positions of the tiles relative to one another can vary depending on the implementation. Further, the specific configuration of tiles being used can change dynamically based on operation of the tile number and resolution selection function 360, which may (among other things) allow for switching back and forth between using foveation rendering and not using foveation rendering. In addition, a combination of these approaches can be used, such as when one tile in FIGS. 7A through 7C has a higher resolution because the user is focusing on that tile or a portion of that tile.

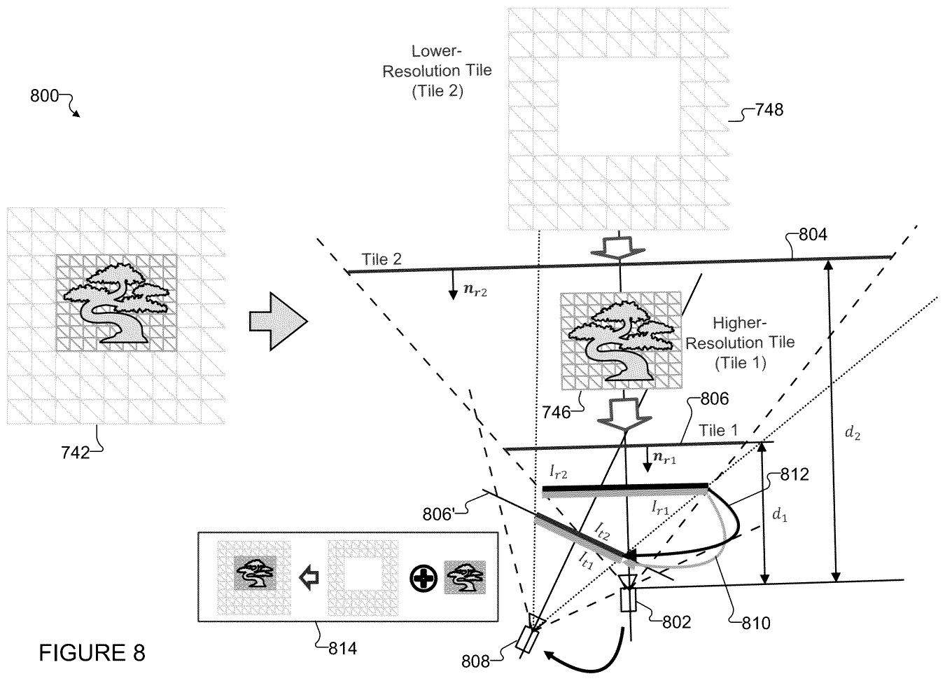

FIG. 8 illustrates an example process 800 for projecting tiles onto a virtual image plane in accordance with this disclosure. For ease of explanation, the process 800 of FIG. 8 is described as being performed using the electronic device 101 in the network configuration 100 of FIG. 1, where the electronic device 101 may perform the tile-based process 250 of FIGS. 2C and 2D and support the architecture 300 of FIGS. 3A and 3B. However, the process 800 may be performed using any other suitable device(s) and in any other suitable system(s), and the process 800 may be used with any other suitable tile-based processes and architectures.

As shown in FIG. 8, a reference camera 802 represents a virtual camera associated with a user's eye. The reference camera 802 therefore represents an imaginary camera that could be used to capture image frames of a scene if located at the position of the user's eye. Part of the transformation process described above for the captured tiles includes transforming the tiles from the viewpoint of an actual see-through camera or other imaging sensor 180 to the viewpoint of the virtual camera. Based on the arrangement of tiles from FIG. 7D, the lower-resolution tile 748 could be projected onto an image plane 804, and the higher-resolution tile 746 could be projected onto an image plane 806. The image plane 806 has a first distance d₁ from the position of the reference camera 802, and the image plane 804 has a second larger distance d₂ from the position of the reference camera 802. Here, Iᵣ₁ and Iᵣ₂ represent rendered and displayed versions of the tiles 746-748 from the perspective of the reference camera 802.

In the presence of head pose changes, however, the imaging sensor 180 can move, and the virtual camera represented by the reference camera 802 may move so that the virtual camera is now represented by a target camera 808. Due to this movement, the image plane 806 has moved and become an image plane 806′, and the image plane 804 may similarly move (although it is not shown here for ease of illustration). The head pose compensation functionality described above can therefore be used to perform transformations 810 and 812. The transformation 810 transforms the first tile 746 from the image plane 806 to the image plane 806′, and the transformation 812 transforms the second tile 748 from the image plane 804 to a corresponding image plane associated with the target camera 808. Here, Iᵣ₁ and I^{r2} represent rendered and displayed versions of the tiles 746-748 from the perspective of the target camera 808.

In some cases, these transformations may be expressed as follows. Assume that the reference camera 802 (denoted cᵣ) has a camera pose sᵣ. The camera pose sᵣ of the reference camera 802 may be expressed as follows.

sᵣ=[Rᵣ|Tᵣ]
Here, Rᵣ is a rotation matrix of the reference camera cᵣ, and Tᵣ is a translation vector of the reference camera cᵣ. Similarly, assume that the target camera 808 (denoted Cₜ) has a camera pose sₜ. The camera pose Sₜ of the target camera 808 may be expressed as follows.

Sₜ=[Rₜ|Tₜ]
Here, Rᵣ is a rotation matrix of the target camera cₜ, and Tₜ is a translation vector of the target camera cₜ. A pose difference Sₜᵣ=[Rₜᵣ|Tₜᵣ] can be determined between the target camera cₜ and the reference camera cᵣ, such as in the following manner.

$${S}_{tr} = {S}_{t} {S}_{r}^{- 1}$$

Based on this, the higher-resolution tile 746 can be projected from the reference camera 802 to the target camera 808, such as in the following manner.

$${p}_{t 1} ( x , y ) = ( {R}_{tr} - {T}_{tr} \frac{{n}_{r 1}}{{d}_{1}} ) {p}_{r 1} ( x , y )$$

Here, nᵣ₁ is a normal vector of the image plane 806, and d₁ is the depth of the image plane 806. Similarly, the lower-resolution tile 748 can be projected from the reference camera 802 to the target camera 808, such as in the following manner.

$${p}_{t 2} ( x , y ) = ( {R}_{tr} - {T}_{tr} \frac{{n}_{r 2}}{{d}_{2}} ) {p}_{r 2} ( x , y )$$

Here, nᵣ₂ is a normal vector of the image plane 804, and d₂ is the depth of the image plane 804. The two projections pₜ₁(x, y), pₜ₂(x, y) can be integrated together to generate the final view for the target camera cₜ, such as in the following manner.

pₜ(x,y)= [symbol] (pₜ₁(x,y),pₜ₂(x,y))

This allows the projected versions of the tiles to be combined (which is represented graphically as an aggregation operation 814) to generate a final rendered view for the target camera 808.

Although FIG. 8 illustrates one example of a process 800 for projecting tiles onto a virtual image plane, various changes may be made to FIG. 8. For example, the process 800 in FIG. 8 can be easily modified to support other tile arrangements, such as the arrangements shown in FIGS. 7A through 7C. In some cases, the projections may be simpler since all tiles having the same resolution can be projected onto a common image plane for the reference camera 802 and onto a common image plane for the target camera 808 (rather than onto multiple image planes).

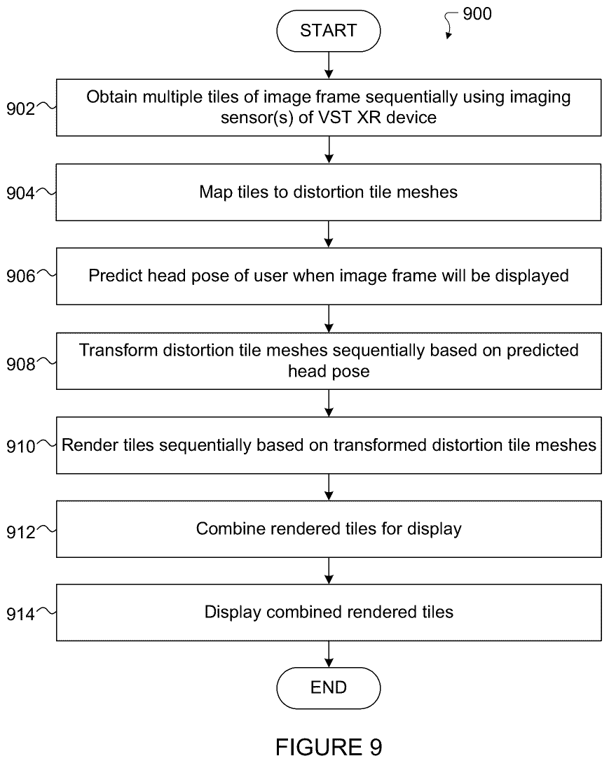

FIG. 9 illustrates an example method 900 for supporting tile processing and transformation for VST XR in accordance with this disclosure. For ease of explanation, the method 900 of FIG. 9 is described as being performed using the electronic device 101 in the network configuration 100 of FIG. 1, where the electronic device 101 may perform the tile-based process 250 of FIGS. 2C and 2D and support the architecture 300 of FIGS. 3A and 3B. However, the method 900 may be performed using any other suitable device(s) and in any other suitable system(s), and the method 900 may be used with any other suitable tile-based processes and architectures.

As shown in FIG. 9, multiple tiles of an image frame are obtained sequentially using one or more imaging sensors of an electronic device at step 902. This may include, for example, the processor 120 of the electronic device 101 sequentially obtaining multiple tiles of an image frame using multiple computing threads. Thus, for instance, a first tile corresponding to a first portion of the image frame can be obtained, and a second tile corresponding to a second portion of the image frame can be obtained after the first tile is obtained. If there are more than two tiles, this may continue by obtaining a third tile after the second tile is obtained, obtaining a fourth tile after the third tile is obtained, etc.

The tiles are mapped to distortion tile meshes at step 904. This may include, for example, the processor 120 of the electronic device 101 extracting a distortion tile mesh for each tile based on the characteristic(s) of that tile from one or more distortion meshes using the multiple threads. As a particular example, the processor 120 of the electronic device 101 may identify a position, size, and resolution of each tile and extract a distortion tile mesh at the same position and with the same size from a distortion mesh having the same resolution. This may also include the processor 120 of the electronic device 101 identifying corresponding points in the tiles and the distortion tile meshes. Note that these mappings may occur sequentially in the multiple threads.

A head pose of a user at a time when the image frame is expected to be displayed is estimated at step 906. This may include, for example, the processor 120 of the electronic device 101 using an IMU, head pose tracking camera, or other sensor(s) 180 of the electronic device 101 along with a head pose model to identify a current head pose of the user and predict what the future head pose of the user might be at a given time in the future. The given time in the future can be based on the estimated latency of the VST XR pipeline in processing, rendering, and displaying the image frame. The distortion tile meshes are transformed sequentially based on the predicted head pose at step 908. This may include, for example, the processor 120 of the electronic device 101 performing transformations to adjust the distortion tile meshes from the image plane(s) at which the tiles are captured to the image plane(s) at the predicted head pose of the user using the multiple threads.

The tiles are rendered sequentially based on the transformed distortion tile meshes at step 910. This may include, for example, the processor 120 of the electronic device 101 applying the transformed distortion tile meshes to the captured tiles using the multiple threads. The rendered tiles may optionally be combined for display at step 912. This may include, for example, the processor 120 of the electronic device 101 combining the rendered tiles into an integrated image frame. The rendered tiles are displayed (either separately or together in the integrated image frame) at step 912. This may include, for example, the processor 120 of the electronic device 101 initiating display of the rendered tiles on at least one display panel of the VST XR device.

Although FIG. 9 illustrates one example of method 900 for supporting tile processing and transformation for VST XR, various changes may be made to FIG. 9. For example, while shown as a series of steps, various steps in FIG. 9 may overlap, occur in parallel, occur in a different order, or occur any number of times (including zero times).

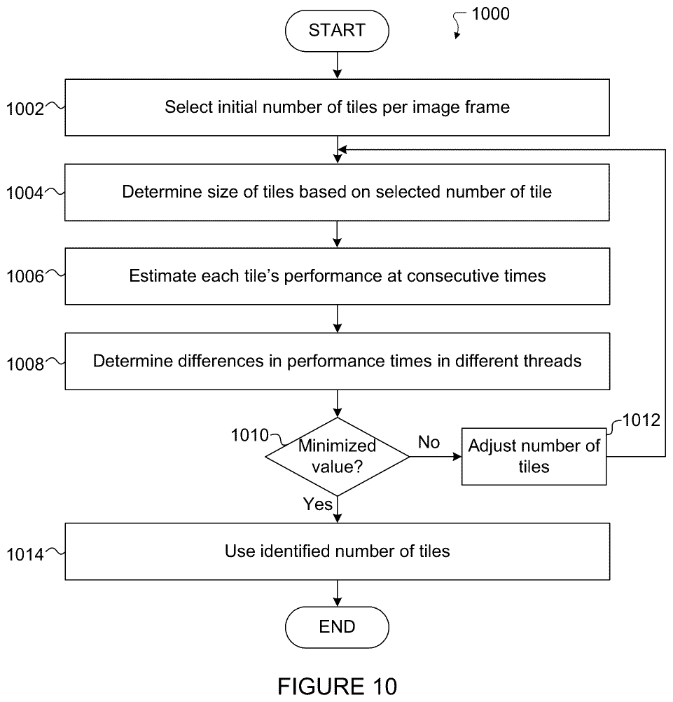

FIG. 10 illustrates an example method 1000 for dynamically controlling numbers and resolutions of tiles in accordance with this disclosure. For ease of explanation, the method 1000 of FIG. 10 is described as being performed using the electronic device 101 in the network configuration 100 of FIG. 1, where the electronic device 101 may perform the tile-based process 250 of FIGS. 2C and 2D and support the architecture 300 of FIGS. 3A and 3B. However, the method 1000 may be performed using any other suitable device(s) and in any other suitable system(s), and the method 1000 may be used with any other suitable tile-based processes and architectures.

As shown in FIG. 10, an initial number of tiles per image frame is selected at step 1002. This may include, for example, the processor 120 of the electronic device 101 selecting two or other number as the initial number of tiles per image frame. A size of each tile is determined based on the selected number of tiles at step 1004. This may include, for example, the processor 120 of the electronic device 101 attempting to evenly divide (at least to the extent practical) an image frame based on the selected number of tiles. The size of each tile may be expressed using width (w) and height (h) values.

Based on the selected number of tiles and their size(s), the performance of the VST XR pipeline with respect to each tile is estimated at consecutive times as the tiles are captured, processed, and rendered at step 1006. This may include, for example, the processor 120 of the electronic device 101 executing multiple threads to capture, process, and render the selected number of tiles and to obtain a performance time (t₁, t₂, . . . , tₙ) for each thread (where n equals the selected number of tiles). Differences between the performance times are determined at step 1008. This may include, for example, the processor 120 of the electronic device 101 calculating performance time differences between the different threads and summing the performance time differences. In some cases, this may be expressed as follows.

$$\{ \begin{matrix}{d}_{12} = {t}_{1} - {t}_{2} \\ {d}_{13} = {t}_{1} - {t}_{3} \\ … \\ {d}_{1 n} = {t}_{1} - {t}_{n} \\ d = {d}_{12} + {d}_{13} + … + {d}_{1 n}\end{matrix} .$$

A determination is made whether the calculated performance time difference value is minimized at step 1010. This may include, for example, the processor 120 of the electronic device 101 determining whether the calculated performance time difference value is at or within a threshold amount of zero. If not, the number of tiles is adjusted at step 1012. This may include, for example, the processor 120 of the electronic device 101 incrementing, decrementing, or otherwise altering the number of tiles. At that point, the process can return to step 1004 to repeat tile capturing, processing, and rendering with the adjusted number of tiles. Otherwise, the selected number of tiles can be used at step 1014. This may include, for example, the processor 120 of the electronic device 101 initiating capture of additional image frames using the identified number of tiles.

Although FIG. 10 illustrates one example of a method 1000 for dynamically controlling numbers and resolutions of tiles, various changes may be made to FIG. 10. For example, while shown as a series of steps, various steps in FIG. 10 may overlap, occur in parallel, occur in a different order, or occur any number of times (including zero times). Also, it should be noted that the method 1000 need not be performed continuously by a VST XR device. In some cases, for instance, the method 1000 may be performed in response to a change in focus mode (such as from foveation rendering to non-foveation rendering or vice versa).

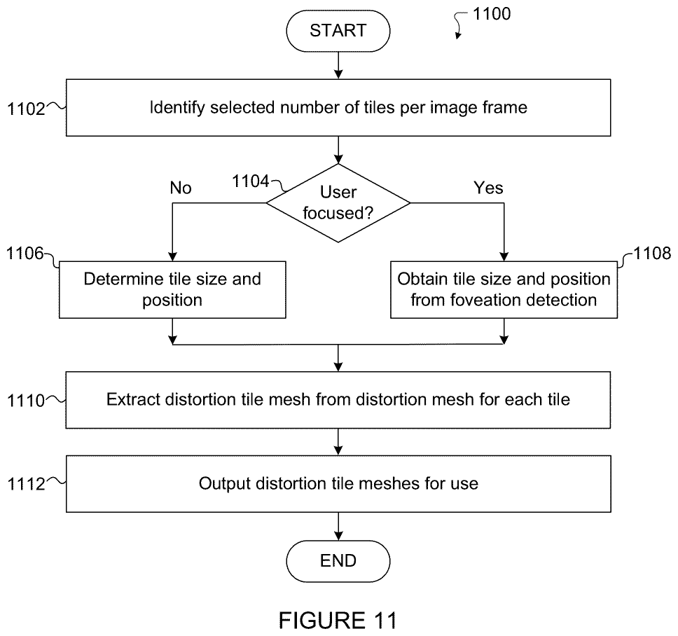

FIG. 11 illustrates an example method 1100 for identifying a tile distortion mesh for use in transforming a tile in accordance with this disclosure. For ease of explanation, the method 1100 of FIG. 11 is described as being performed using the electronic device 101 in the network configuration 100 of FIG. 1, where the electronic device 101 may perform the tile-based process 250 of FIGS. 2C and 2D and support the architecture 300 of FIGS. 3A and 3B. However, the method 1100 may be performed using any other suitable device(s) and in any other suitable system(s), and the method 1100 may be used with any other suitable tile-based processes and architectures.

As shown in FIG. 11, a selected number of tiles to be used per image frame is identified at step 1102. This may include, for example, the processor 120 of the electronic device 101 performing the method 1000 described above or using the results of the method 1000 as previously performed. A determination is made whether the user is focused on a particular region of interest in a scene at step 1104. This may include, for example, the processor 120 of the electronic device 101 using one or more eye tracking sensors or other sensors 180 of the electronic device 101 to determine whether the user's eyes are focused on a particular region of image frames being presented to the user.

If the user is not focused on a particular region of interest in the scene, tile sizes and positions may be determined based on the number of tiles at step 1106. This may include, for example, the processor 120 of the electronic device 101 dividing image frames into the identified number of tiles, which can have generally equal sizes and may have a suitable arrangement. In some cases, the size of each tile may be defined as follows.

$$\{ \begin{matrix}w = {w}_{d} \\ h = \frac{{h}_{d}}{n}\end{matrix}$$

Here, w and h represent the size of each tile, n represents the number of tiles, and w_{d} represents the width of the distortion mesh associated with the image frames to be captured. Also, the position of each tile may be defined as follows.

$$\{ \begin{matrix}x = 0 \\ y = ( i - 1 ) h\end{matrix}$$

Here, i=1, 2, . . . , n represents the index of the tile. Otherwise, if the user is focused on a particular region of interest in the scene, the tile sizes and positions can be obtained using foveation detection at step 1108. This may include, for example, the processor 120 of the electronic device 101 determining a higher-resolution tile as including the area in which the user is focused, along with one or more lower-resolution tiles in other non-focus areas of a scene.

Based on the determined position and size of each tile, a distortion tile mesh is extracted from a distortion mesh for each tile at step 1110. This may include, for example, the processor 120 of the electronic device 101 extracting, for each identified tile, a portion of a corresponding distortion mesh having the same resolution as that tile, where the portion of the corresponding distortion mesh has the same position and size as that tile. If all tiles have the same resolution, the distortion tile meshes can be extracted from a single distortion mesh. If different tiles have different resolutions, different distortion tile meshes can be extracted from different distortion meshes. The distortion tile meshes are output for use at step 1112. This may include, for example, the processor 120 of the electronic device 101 providing the distortion tile meshes so that tiles can be mapped onto the distortion tile meshes.

Although FIG. 11 illustrates one example of a method 1100 for identifying a tile distortion mesh for use in transforming a tile, various changes may be made to FIG. 11. For example, while shown as a series of steps, various steps in FIG. 11 may overlap, occur in parallel, occur in a different order, or occur any number of times (including zero times).

It should be noted that the functions shown in or described with respect to FIGS. 2A through 11 can be implemented in an electronic device 101, 102, 104, server 106, or other device(s) in any suitable manner. For example, in some embodiments, at least some of the functions shown in or described with respect to FIGS. 2A through 11 can be implemented or supported using one or more software applications or other software instructions that are executed by the processor 120 of the electronic device 101, 102, 104, server 106, or other device(s). In other embodiments, at least some of the functions shown in or described with respect to FIGS. 2A through 11 can be implemented or supported using dedicated hardware components. In general, the functions shown in or described with respect to FIGS. 2A through 11 can be performed using any suitable hardware or any suitable combination of hardware and software/firmware instructions. Also, the functions shown in or described with respect to FIGS. 2A through 11 can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining, using at least one imaging sensor of a video see-through (VST) extended reality (XR) device, (i) a first tile corresponding to a first portion of an image frame and (ii) a second tile corresponding to a second portion of the image frame after the first tile is obtained;
mapping, using at least one processing device of the VST XR device, the first tile onto a first distortion tile mesh, the first distortion tile mesh based on one or more characteristics of the first tile;
mapping, using the at least one processing device, the second tile onto a second distortion tile mesh, the second distortion tile mesh based on one or more characteristics of the second tile;
predicting, using the at least one processing device, a head pose of a user when the image frame will be displayed;
transforming, using the at least one processing device, the first and second distortion tile meshes based on the predicted head pose, the second distortion tile mesh transformed after the first distortion tile mesh;
rendering, using the at least one processing device, the first and second tiles for display based on the first and second transformed distortion tile meshes, respectively, the second tile rendered after the first tile; and
initiating, using the at least one processing device, display of the first and second rendered tiles on at least one display panel of the VST XR device.

2. The method of claim 1, wherein:
a first thread executed by the at least one processing device maps the first tile, transforms the first distortion tile mesh, and renders the first tile; and
a second thread executed by the at least one processing device maps the second tile, transforms the second distortion tile mesh, and renders the second tile.

3. The method of claim 1, wherein:
each of the first and second distortion tile meshes is generated based on a selected base distortion mesh of a set of base distortion meshes having different resolutions; and
the selected base distortion mesh for one of the distortion tile meshes is selected based on a region of the image frame on which eyes of the user are focused.

4. The method of claim 3, wherein each base distortion mesh is generated during initialization of the VST XR device by:
creating an initial base distortion mesh based on one or more characteristics of the at least one imaging sensor; and
transforming the initial base distortion mesh to correct for lens distortion, viewpoint differences between the eyes of the user and the at least one imaging sensor, and parallax.

5. The method of claim 1, further comprising:
obtaining, using the at least one imaging sensor, a third tile corresponding to a third portion of the image frame after the second tile is obtained;
mapping, using the at least one processing device, the third tile onto a third distortion tile mesh, the third distortion tile mesh based on one or more characteristics of the third tile;
transforming, using the at least one processing device, the third distortion tile mesh based on the predicted head pose, the third distortion tile mesh transformed after the second distortion tile mesh;
rendering, using the at least one processing device, the third tile for display on the at least one display panel based on the third transformed distortion tile mesh, the third tile rendered after the second tile; and
initiating, using the at least one processing device, display of the third rendered tile on the at least one display panel of the VST XR device.

6. The method of claim 1, wherein the first and second tiles partially overlap.

7. The method of claim 1, further comprising:
dynamically selecting a number of tiles and a resolution of each of the tiles based on performance of a pipeline that obtains tiles for multiple image frames and generates rendered images based on the obtained tiles.

8. A video see-through (VST) extended reality (XR) device comprising:
at least one imaging sensor configured to (i) capture a first tile corresponding to a first portion of an image frame and (ii) capture a second tile corresponding to a second portion of the image frame after the first tile is captured; and
at least one processing device configured to:
map the first tile onto a first distortion tile mesh, the first distortion tile mesh based on one or more characteristics of the first tile;
map the second tile onto a second distortion tile mesh, the second distortion tile mesh based on one or more characteristics of the second tile;
predict a head pose of a user when the image frame will be displayed;
transform the first and second distortion tile meshes based on the predicted head pose, the at least one processing device configured to transform the second distortion tile mesh after the first distortion tile mesh;
render the first and second tiles for display based on the first and second transformed distortion tile meshes, respectively, the at least one processing device configured to render the second tile after the first tile; and
initiate display of the first and second rendered tiles on at least one display panel of the VST XR device.

9. The VST XR device of claim 8, wherein the at least one processing device is configured to:
execute a first thread to map the first tile, transform the first distortion tile mesh, and render the first tile; and
execute a second thread to map the second tile, transform the second distortion tile mesh, and render the second tile.

10. The VST XR device of claim 8, wherein the at least one processing device is further configured to:
generate each of the first and second distortion tile meshes based on a selected base distortion mesh of a set of base distortion meshes having different resolutions; and
select the selected base distortion mesh for one of the distortion tile meshes based on a region of the image frame on which eyes of the user are focused.

11. The VST XR device of claim 10, wherein:
the at least one processing device is further configured to generate each base distortion mesh during initialization of the VST XR device; and
to generate each base distortion mesh, the at least one processing device is configured to:
create an initial base distortion mesh based on one or more characteristics of the at least one imaging sensor; and
transform the initial base distortion mesh to correct for lens distortion, viewpoint differences between the eyes of the user and the at least one imaging sensor, and parallax.

12. The VST XR device of claim 8, wherein:
the at least one imaging sensor is further configured to capture a third tile corresponding to a third portion of the image frame after the second tile is captured; and
the at least one processing device is further configured to:
map the third tile onto a third distortion tile mesh, the third distortion tile mesh based on one or more characteristics of the third tile;
transform the third distortion tile mesh based on the predicted head pose, the at least one processing device configured to transform the third distortion tile mesh after the second distortion tile mesh; and
render the third tile for display based on the third transformed distortion tile mesh, the at least one processing device configured to render the third tile after the second tile; and
initiate display of the third rendered tile on the at least one display panel of the VST XR device.

13. The VST XR device of claim 8, wherein the first and second tiles partially overlap.

14. The VST XR device of claim 8, wherein the at least one processing device is further configured to dynamically select a number of tiles and a resolution of each of the tiles based on performance of a pipeline that obtains tiles for multiple image frames and generates rendered images based on the obtained tiles.

15. A non-transitory machine readable medium containing instructions that when executed cause at least one processor of a video see-through (VST) extended reality (XR) device to:
obtain, using at least one imaging sensor of the VST XR device, (i) a first tile corresponding to a first portion of an image frame and (ii) a second tile corresponding to a second portion of the image frame after the first tile is obtained;
map the first tile onto a first distortion tile mesh, the first distortion tile mesh based on one or more characteristics of the first tile;
map the second tile onto a second distortion tile mesh, the second distortion tile mesh based on one or more characteristics of the second tile;
predict a head pose of a user when the image frame will be displayed;
transform (i) the first distortion tile mesh based on the predicted head pose and (ii) the second distortion tile mesh based on the predicted head pose after the first distortion tile mesh is transformed;
render (i) the first tile for display based on the first transformed distortion tile mesh and (ii) the second tile for display based on the second transformed distortion tile mesh after the first tile is rendered; and
initiate display of the first and second rendered tiles on at least one display panel of the VST XR device.

16. The non-transitory machine readable medium of claim 15, wherein the instructions when executed cause the at least one processor to:
execute a first thread to map the first tile, transform the first distortion tile mesh, and render the first tile; and
execute a second thread to map the second tile, transform the second distortion tile mesh, and render the second tile.

17. The non-transitory machine readable medium of claim 15, wherein the instructions when executed cause the at least one processor to:
generate each of the first and second distortion tile meshes based on a selected base distortion mesh of a set of base distortion meshes having different resolutions; and
select the selected base distortion mesh for one of the distortion tile meshes based on a region of the image frame on which eyes of the user are focused.

18. The non-transitory machine readable medium of claim 17, further containing instructions that when executed cause the at least one processor to generate each base distortion mesh during initialization of the VST XR device;
wherein the instructions that when executed cause the at least one processor to generate each base distortion mesh comprise instructions that when executed cause the at least one processor to:
create an initial base distortion mesh based on one or more characteristics of the at least one imaging sensor; and
transform the initial base distortion mesh to correct for lens distortion, viewpoint differences between the eyes of the user and the at least one imaging sensor, and parallax.

19. The non-transitory machine readable medium of claim 15, further containing instructions that when executed cause the at least one processor to:
obtain a third tile corresponding to a third portion of the image frame after the second tile is obtained;
map the third tile onto a third distortion tile mesh, the third distortion tile mesh based on one or more characteristics of the third tile;
transform the third distortion tile mesh based on the predicted head pose after the second distortion tile mesh is transformed;
render the third tile for display on the at least one display panel based on the third transformed distortion tile mesh after the second tile is rendered; and
initiate display of the third rendered tile on the at least one display panel of the VST XR device.

20. The non-transitory machine readable medium of claim 15, further containing instructions that when executed cause the at least one processor to dynamically select a number of tiles and a resolution of each of the tiles based on performance of a pipeline that obtains tiles for multiple image frames and generates rendered images based on the obtained tiles.
